(19) United States
(12) Patent Application Publication
(10) Pub. No.: US 2002/0114380 A1
(43) Pub. Date: Aug. 22, 2002

(54) Combined pre-equalizer and nyquist filter

(76) Inventors: Xiaoshu Qian, Cupertino, CA (US); David H. Tran, Los Altos, CA (US); Ahmed Said, Fremont, CA (US)

Correspondence Address: Seth Z. Kalson, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/745,598

(22) Filed: Dec. 21, 2000

(51) Int. Cl. H04B 1/10; H04B 1/38; H04L 5/16

(52) U.S. Cl. 375/222; 375/350

(57) ABSTRACT

A filter for performing combined Nyquist filtering and pre-equalization in a cable modem.

### FIELD

Embodiments of the present invention relate to digital signal processing, and more particularly, digital signal processing for a cable modem.

### BACKGROUND

Cable modems allow for communicating via CATV (Community Access Television) coaxial cable. Specifications for cable modems are published under the auspices of Cable Television Laboratories, also known as CableLabs®, www.cablelabs.com, a non-profit research and development consortium of cable system operators. FIG. 1 illustrates a functional block diagram for the physical layer of a prior art cable modem according to DOCSIS (Data Over Cable Service Interface Specification), see CableLabs.

In FIG. 1, block framer 102 frames digital data, and provides these frames to Reed-Solomon encoder 104. Randomizer 106 reduces any constant component (e.g., a string of zeros) in the output of Reed-Solomon encoder 104. Preamble 108 provides a training sequence, used by a receiver at the head end (not shown) for TDMA (Time Division Multiple Access) communication. Symbol map 110 maps digital data to a symbol chosen from a 16 QAM (Quadrature Amplitude Modulation) signal constellation. Each of these symbols may be represented by 2 bits for the I (In-phase) component and 2 bits for the Q (Quadrature) component. Nyquist filter 112 filters the digital output from symbol map 110 so as to reduce ISI (Inter-Symbol Interference). Modulator 114 up-converts the digital signal, and digital-to-analog 116 converts the digital signal to an analog signal. Cable interface 118 provides the proper interface to cable 120.

Nyquist filter 112 is a real-valued digital filter. Nyquist filter 112 provides interpolation, so that the time spacing of a discrete-time signal at the output of Nyquist filter 112 is less than the time spacing of a discrete-time signal at its input. An embodiment of Nyquist filter 112 is illustrated in FIG. 2, where Nyquist filter 112 is implemented as a FIR (Finite Impulse Response) filter, and the interpolation is such that if the time spacing of a discrete-time signal to the input of Nyquist filter 112 is denoted by T, then the time spacing of a discrete-time signal at its output is T/4. The filter of FIG. 2 is implemented as a tap delay line, with unit delay elements 202. The filter tap weights are denoted by c(i), i=0,1, . . . , N−1, where N is the filter length. Adder unit 202 adds the weighted results to provide the filtered output. Interpolation element 206 indicates that three zeroes are inserted for each input date symbol. In practice, there would be one filter for the in-phase component and one filter for the quadrature component, but for simplicity, only one filter is illustrated in FIG. 2.

A change to the cable modem standard DOCSIS (Radio Frequency Interface Specification, SP-RFIv1.1-I02-990731) requires that a transmit pre-equalizer be supported in a cable modem at subscriber locations. The output of Nyquist filter 112 for some embodiments is 10 bits, and consequently applying a pre-equalizer to the output of Nyquist filter 112 would require 10 bit by 10 bit multiplication, and this substantial increase in numerical processing leads to an increase in die area to perform the transmit pre-equalization. Consequently, there is a need to provide practical implementations of a pre-equalizer in a cable modem without substantially increasing die area.

### BRIEF DESCRIPTION OF THE DRAWINGS

FIG. 1 is a functional diagram of a cable modem.

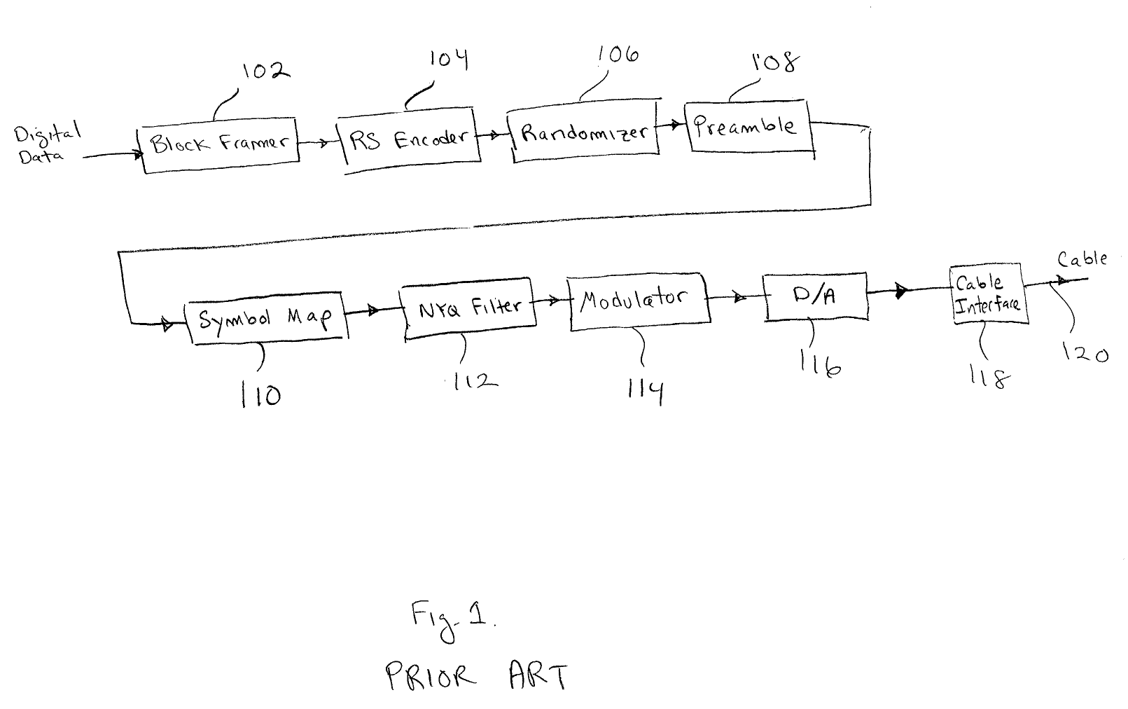

FIG. 2 is a Nyquist filter.

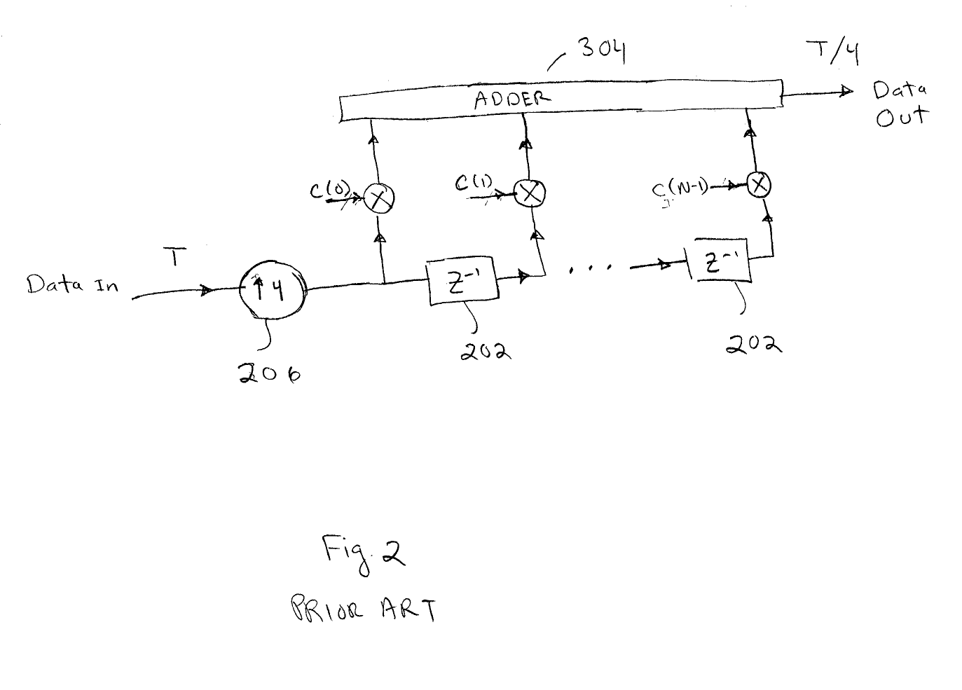

FIG. 3 is a flow diagram for obtaining the in-phase and quadrature filter coefficients of an embodiment of the invention.

FIG. 4 is a filter for Nyquist filtering and pre-equalization according to an embodiment of the invention to obtain in-phase components.

FIG. 5 is a filter for Nyquist filtering and pre-equalization according to an embodiment of the invention to obtain quadrature components.

FIG. 6 is another filter structure for a sub-block of the filter in FIG. 5.

FIG. 7 illustrates a computer system employing an embodiment of the present invention.

### DESCRIPTION OF EMBODIMENTS

Embodiments according to the present invention provide efficient pre-equalization by combining a pre-equalizer with a Nyquist filter. Combining pre-equalization with Nyquist filtering results in a filter structure having no more inherent complexity than a Nyquist filter by itself. In particular, the numerical computations involved in filter weight multiplication are no more involved than performing Nyquist filtering by itself.

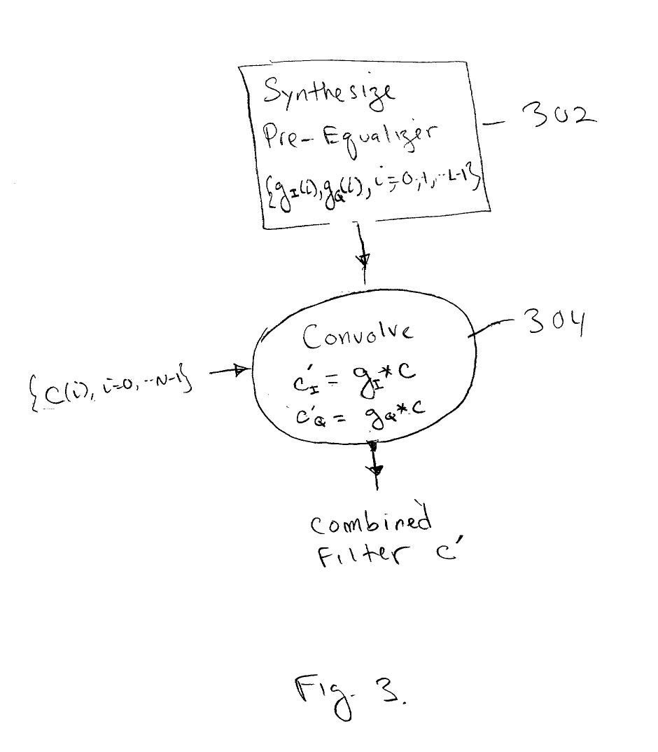

A flow diagram illustrating the synthesis of the combined filter is provided in FIG. 3. For box 302 a pre-equalizer is synthesized as an FIR filter having impulse response (filter weights) g(i)=g_{I}(i)+jg_{Q}(i), i=0,1, . . . L−1, where g_{I}(i) are the in-phase components of the filter weights g(i) and g_{Q}(i) are the quadrature components of the filter weights g(i). This synthesis may be accomplished by any well-known technique, such as measuring the impulse response of the cable channel and equalizing accordingly.

For box 304, given the Nyquist filter impulse response c(i), i=0,1,.N−1, the combined filter, denoted as c′(i)=c′_{I}(i)+jc′_{Q}(i), i=0,1, . . . , N+L−2, is given by c′=g*c, where * denotes convolution. That is,

$${c}^{′} ( i ) = {\sum }_{k = 0}^{L - 1} g ( k ) c ( i - k ) ,$$

where it is understood that c(i)=0 for i<0 or i>N−1. For the embodiment of FIG. 3, the c(i) are real-valued, so that c′_{I}=g_{I}* c and c′_{Q}=g_{Q}*c.

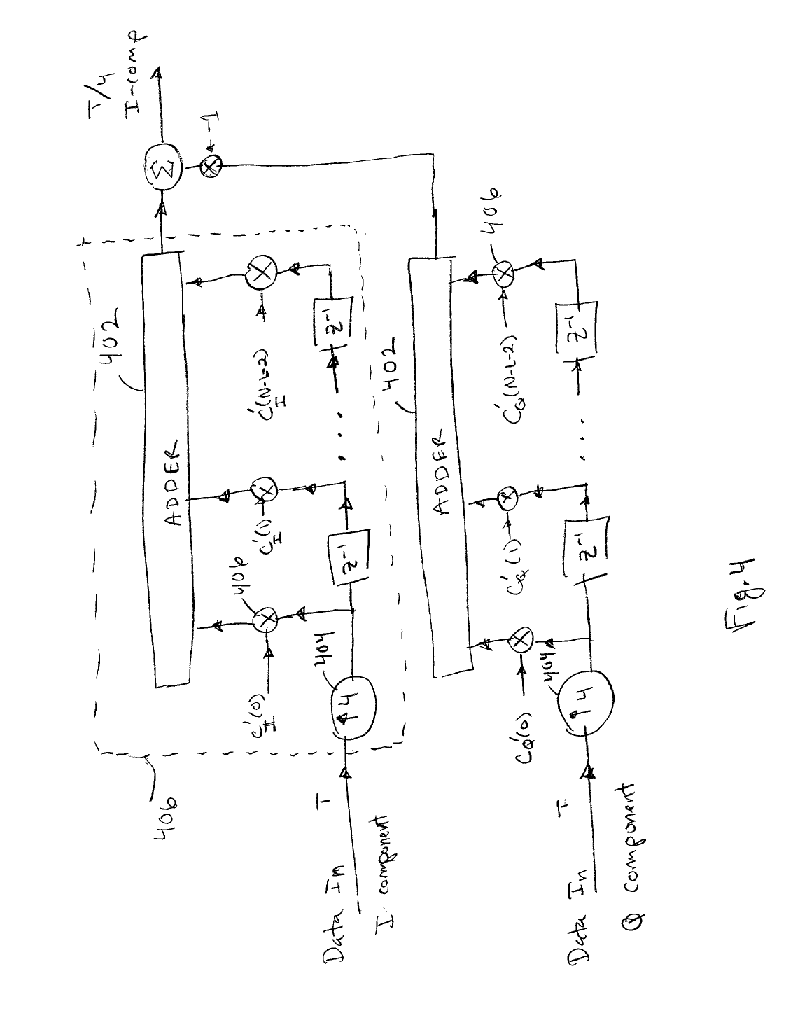

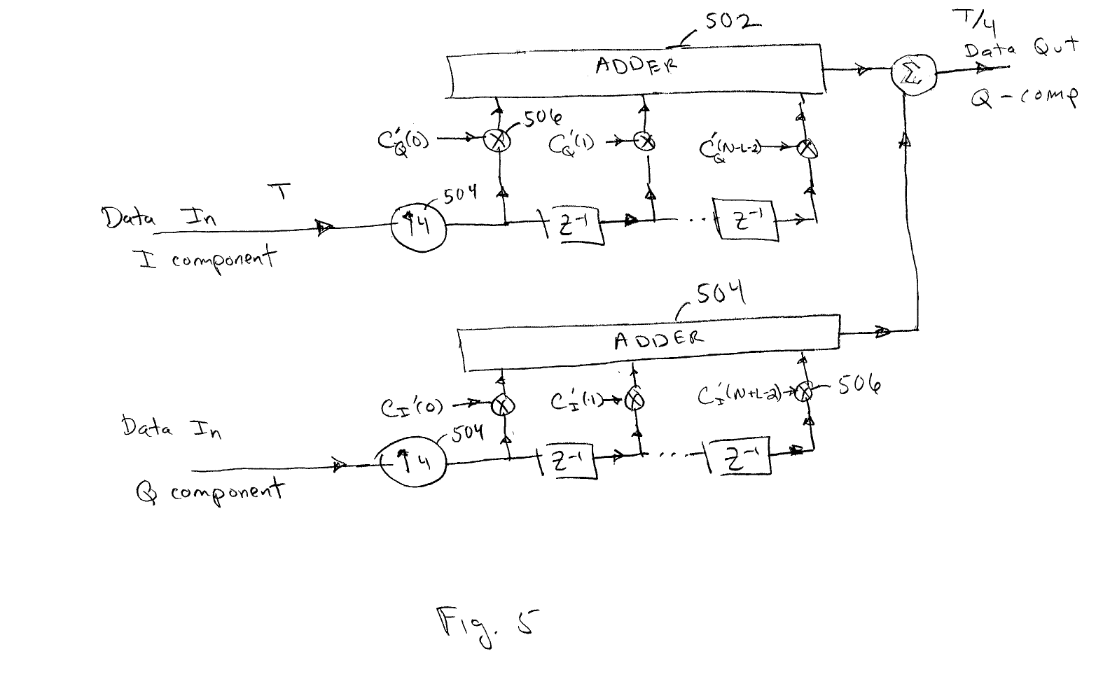

The embodiment of FIG. 4 may be employed to obtain the in-phase components for Nyquist and pre-equalized filtered output data in which the combined filter weights are given as indicated in the flow diagram of FIG. 3. Similarly, the embodiment of FIG. 5 may be employed to obtain the quadrature component for the output data.

The in-phase and quadrature components of the input discrete-time signal to the filters of FIGS. 4 and 5 are each 2 bits. Multipliers 406 and 506 in FIGS. 4 and 5 need only perform 2 bit by J bit multiplication, where J is the word length of the filtered output in bits. For example, in one embodiment, the in-phase and quadrature inputs to modulator 114 are 10 bits, so that the filter weights in FIGS. 4 and 5 are 10 bits and multipliers 406 and 506 perform 2 bit by 10 bit multiplication. Multiplication by a 2 bit number is relatively easy to implement in hardware, requiring only a bit shift followed by addition. Note that if Nyquist filtering and pre-equalization are not combined as described in FIG. 3, but instead pre-equalization is performed after Nyquist filtering, then providing 10 bit outputs would require 10 bit by 10 bit multiplication, which is more costly than simple 2 bit by 10 bit multiplication.

As described before, interpolation elements 404 and 504 in FIGS. 4 and 5 insert three zeros for each received sample of the input discrete-time signal, so that the resulting filtered output is provided at four times the data rate as the input to the filter. Adders 402 and 502 in FIGS. 4 and 5 add the resulting 10 bit numbers from multipliers 406 and 506 to provide the filtered output. Adders 402 and 502 also round the resulting addition, so that the final output has J bit word length, where in one embodiment, J=10.

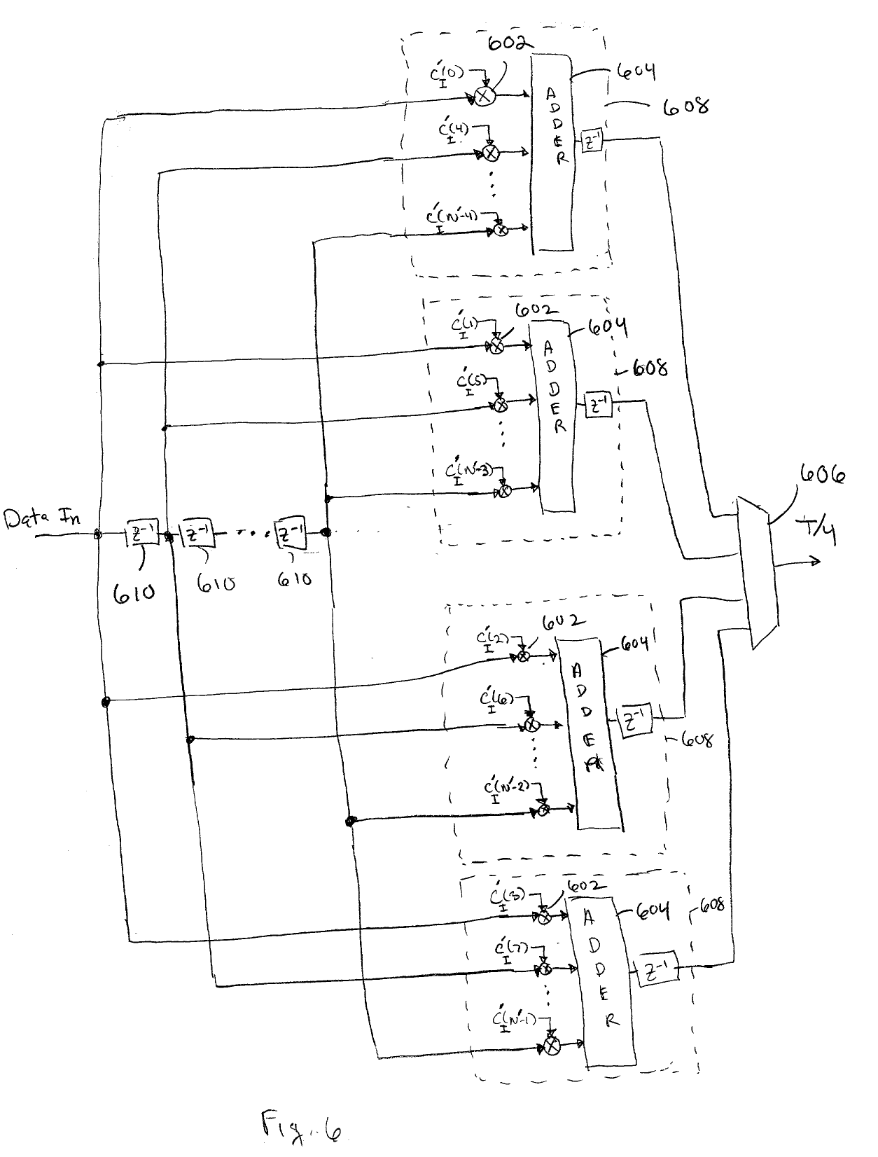

Various other known filter structures may be employed to perform combined Nyquist filtering and pre-equalization. For example, FIG. 6 is an alternative filter implementation for sub-block 406 of FIG. 4, where in FIG. 6 N′=N−L−1. Filters similar in structure to that of FIG. 6 may also be used for other sub-blocks (not shown) in FIGS. 4 and 5. The filter structure of FIG. 6 has several advantages over that of FIG. 4. Multipliers 602 in FIG. 6 operate at the input data rate, whereas multipliers 406 in FIG. 4 operate at four times the input data rate. Similarly, adders 604 operate at the input data rate. Multiplexer 606, however, operates at four times the input data rate, and multiplexes the output of sub-blocks 608 to provide an output signal at four times the input data rate. Because of round-off errors, the filter of FIG. 6 will often not be numerically identical to that of FIG. 4. Another important advantage of the filter in FIG. 6 is the savings in delay elements 610. The filter in FIG. 6 has approximately one-fourth as many delay elements as sub-block 406 in FIG. 4. Many other well-known filter structures may be utilized to perform the filtering indicated in FIG. 4, although the final filtered output may not be identical to that of FIG. 4 due to round off error.

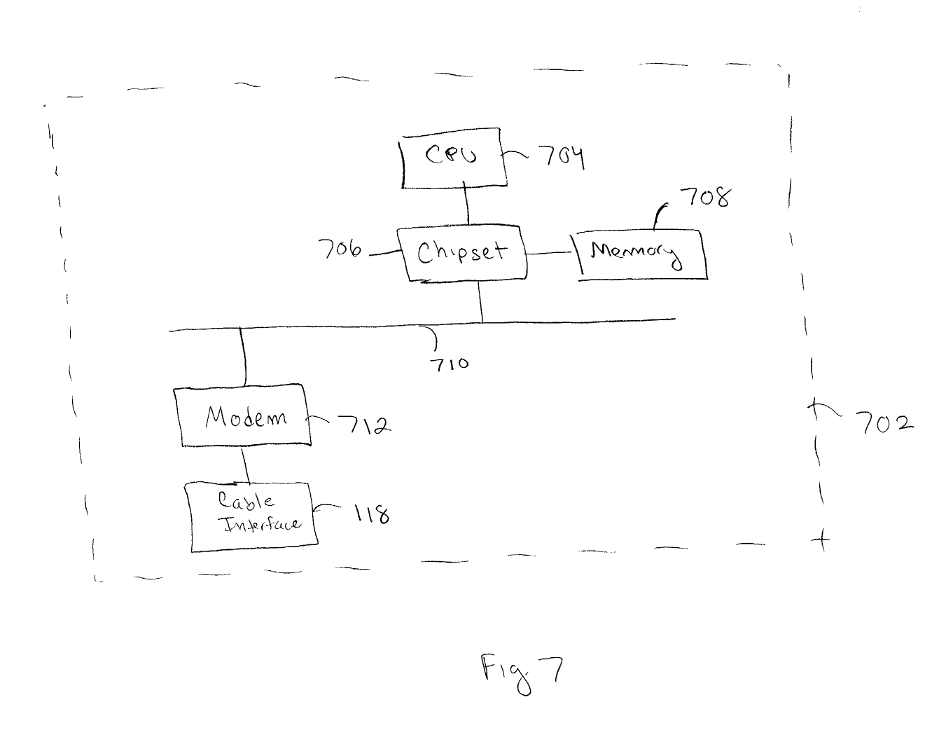

Embodiments of the present invention may be employed in many devices and systems. One such system is illustrated in FIG. 7, where computer system 702 comprises central processing unit (CPU) 704, chipset 706, system memory 708, and system bus 710. Modem 712 is coupled to a cable (not shown) through cable interface 118, and is coupled to system bus 710 to communicate with CPU 704.

Clearly, various modifications may be made to the disclosed embodiments without departing from the scope of the invention as claimed below.

I claim:

1. A filter comprising:
at least one multiplier to multiply samples of an input discrete-time signal by a set of filter weights to provide a resulting discrete-time signal, wherein the filter weights are the convolution of a set of Nyquist filter weights with a set of pre-equalizer filter weights; and
at least one adder to add samples of the resulting discrete-time signal.

2. The filter as set forth in claim 1, wherein the multipliers are 2 bit by J bit multipliers, where J is greater than two.

3. The filter as set forth in claim 1, wherein the input discrete-time signal is a two-bit QAM signal.

4. A modem comprising:
a symbol mapper to provide an input discrete-time signal; and
a filter comprising:
at least one multiplier to multiply samples of the input discrete-time signal by a set of filter weights to provide a resulting discrete-time signal, wherein the filter weights are a convolution of a set of Nyquist filter weights with a set of pre-equalizer filter weights; and
at least one adder to add samples of the resulting discrete-time signal to provide an output discrete-time signal.

5. The modem as set forth in claim 4, wherein the modem is a cable modem.

6. The modem as set forth in claim 4, wherein the multipliers are 2 bit by J bit multipliers, where J is greater than two.

7. The modem as set forth in claim 4, wherein the input discrete-time signal is a two-bit QAM signal.

8. The modem as set forth in claim 4, further comprising:
a modulator to modulate the output discrete-time signal to provide a modulated discrete-time signal;
a digital-to-analog circuit to convert the modulated discrete-time signal to an analog signal; and
a cable interface circuit to propagate the analog signal on a cable.

9. The modem as set forth in claim 8, wherein the multipliers are 2 bit by J bit multipliers, where J is greater than two.

10. The modem as set forth in claim 8, wherein the input discrete-time signal is a two-bit QAM signal.

11. A method to provide Nyquist filtering and pre-equalization, the method comprising:
multiplying samples of an input discrete-time signal by a set of filter weights to provide a resulting discrete-time signal, wherein the filter weights are a convolution of a set of Nyquist filter weights with a set of pre-equalizer filter weights; and
adding samples of the resulting discrete-time signal to provide an output discrete-time signal.

12. The method as set forth in claim 11, wherein the multiplication is 2 bit by J bit multiplication, where J is greater than two.

13. The method as set forth in claim 11, wherein the input discrete-time signal is a two-bit QAM signal.

14. The method as set forth in claim 11, further comprising:
mapping frame symbols into two-bit QAM symbols to provide the input discrete-time signal.

15. The method as set forth in claim 14, further comprising:
modulating the output discrete-time signal to an analog signal; and
propagating the analog signal on a cable.

16. A computer system comprising:
a modem comprising
a symbol mapper to provide an input discrete-time signal; and
a filter comprising:
at least one multiplier to multiply samples of the input discrete-time signal by a set of filter weights to provide a resulting discrete-time signal, wherein the filter weights are a convolution of a set of Nyquist filter weights with a set of pre-equalizer filter weights; and
at least one adder to add samples of the resulting discrete-time signal to provide an output discrete-time signal.

17. The computer system as set forth in claim 16, wherein the modem is a cable modem.

18. The computer system as set forth in claim 16, wherein the multipliers are 2 bit by J bit multipliers, where J is greater than two.
